(19) United States
(12) Patent Application Publication
(10) Pub. No.: US 2001/0028312 A1
(43) Pub. Date: Oct. 11, 2001

(54) Wheel counter mechanism

(76) Inventors: Daniel Matter, Brugg (CH); Walter Rueegg, Endingen (CH); Thomas Christen, Vogelsang (CH)

Correspondence Address: BURNS DOANE SWECKER & MATHIS L L P, POST OFFICE BOX 1404, ALEXANDRIA, VA, 22313-1404, US

(21) Appl. No.: 09/781,228

(22) Filed: Feb. 13, 2001

(30) Foreign Application Priority Data
Feb. 14, 2000 (DE) 100 06 503.1

(51) Int. Cl. G08C 15/06; G08C 19/16

(52) U.S. Cl. 340/870.02; 340/870.37

(57) ABSTRACT

An apparatus for capacitively determining a position of a counter wheel (1) in a wheel counter mechanism has fixed electrodes (3, 3′) at a distance from the counter wheel (1). Extending over the circumference of the counter wheel (1) are a sequence of measurement electrodes (12, 12′, 12″), and electrically nonconductive sections (13, 13′) arranged between said measurement electrodes. This means that it is possible to detect either a high or a low capacitance value, that is to say a binary value of either 0 or 1, for each position of the counter wheel and for each fixed electrode. According to the number of fixed electrodes for each counter wheel, these binary values can be combined to form a binary representation of any desired number characterizing the current position of the counter wheel (1).

### DESCRIPTION

The invention relates to an apparatus for capacitively determining a position of a counter wheel in accordance with the precharacterizing clause of patent claim 1.

Wheel counter mechanisms, in particular household meters for water, gas, electricity or district heating, are in many cases still read by making a personal inspection in situ, that is to say in a consumer's home. This type of consumption recording is time consuming and cost intensive. It is therefore desirable to produce wheel counter mechanisms having electronic reading apparatuses which permit remote reading. In this context, contactless reading apparatuses are preferable as they are subject to fewer manifestations of wear and therefore generally have better long-term stability.

Wheel counter mechanisms having contactless reading apparatuses are known from U.S. Pat. No. 5,554,981. These apparatuses make it possible to determine rotational positions of counter wheels of the wheel counter mechanism capacitively. For this purpose, each counter wheel is arranged at a distance from fixed electrodes, with an air gap inbetween, and is mounted so as to be able to rotate on a bearing axle. The bearing axle is grounded and forms an opposing electrode, so that the body of the counter wheel forms a capacitor dielectric together with the air gap. In this context, the body is designed such that the dielectric constant of the capacitor changes as the body rotates. In one embodiment, the end face of the counter body has, for this purpose, a circumferential electrically nonconductive element whose thickness decreases continuously at the circumference, so that the air gap varies depending on the position of the counter wheel. The capacitor thus has a capacitance which changes constantly with the position of the counter wheel and which can be associated with the corresponding position of the counter wheel using evaluation electronics. This apparatus has the disadvantage that analog capacitance signals need to be associated with discrete positions of the counter wheel. This firstly necessitates complex calibration of the evaluation electronics, in particular in order to compensate for manufacturing tolerances. Secondly, the materials are subject to aging processes which change the signal and thus result in reading errors.

In another embodiment of U.S. Pat. No. 5,554,981, the surface of the counter wheel is split into four rings, each ring comprising four nonconductive sections having different dielectric constants. Each ring has an associated fixed electrode, so that each fixed electrode supplies four capacitance values to the evaluation electronics. These four times four capacitance values provide coded values which can be directly associated with the individual discrete positions of the counter wheel. This apparatus firstly has the disadvantage that the wheel is of relatively complicated design and is therefore relatively expensive to manufacture. In addition, the air gap present between the counter wheel and the fixed electrodes provides the main contribution to the measured capacitance, which means that the measured capacitance values hardly differ from one another.

It is therefore an object of the invention to produce an apparatus for capacitively determining a position of a counter wheel of the type mentioned initially which is simple to manufacture and yet permits the positions of the counter wheel to be read easily.

This object is achieved by an apparatus having the features of patent claim 1.

The apparatus according to the invention has measurement electrodes which are arranged so as to be distributed over the circumference of a counter wheel and are isolated by electrically nonconductive sections arranged between them. This means that, according to the number of positions of the counter wheel which need to be detected, sequences of measurement electrodes and nonconductive sections, and also associated arrangements of fixed electrodes, can be formed which provide either a high or a low capacitance value, that is to say a binary value of 0 or 1, for each position of the counter wheel and for each fixed electrode. According to the number of fixed electrodes for each counter wheel, these binary values can be combined to form a binary representation of any desired number.

The demands to be made on evaluation electronics are thus relatively simple. Furthermore, aging processes and manufacturing tolerances have a negligible influence on the capacitance measurement, since a distinction need be drawn only between a high and a low value. Another advantage is that the apparatus according to the invention permits, as before, a clear view of part of the circumference of the counter wheel, which means that the positions which can be characterized by means of numbers on the circumference can still be read visually.

In one preferred embodiment of the invention, the counter wheel is made from a nonconductive material, with measurement electrodes arranged on its surface or in recesses in its surface.

In another embodiment, the counter wheel itself is made of an electrically conductive material, and recesses contain electrically nonconductive inserts distributed over the circumference.

In one embodiment, fixed electrodes and an opposing electrode are provided, these being arranged at a distance from the counter wheel.

In another, preferred embodiment, the fixed electrodes are combined to form pairs comprising a transmitter electrode and a receiver electrode. This embodiment has the advantage that crosstalk between the individual electrodes is largely prevented. In addition, erroneous measurements caused by any imbalance or by a change in the axial position of the counter wheel are minimized.

Further advantageous embodiments can be found in the dependent patent claims.

The subject matter of the invention is explained in more detail below with the aid of preferred illustrative embodiments which are shown in the accompanying drawings, in which:

FIG. 1 shows a schematic illustration of a wheel counter mechanism;

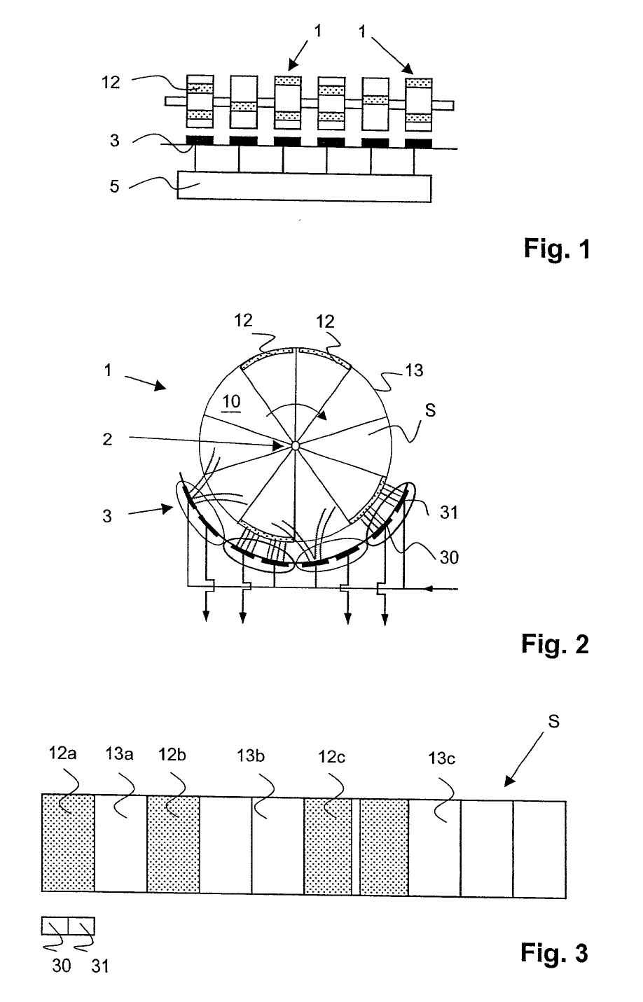

FIG. 2 shows a side view of a first embodiment of a counter wheel having the reading apparatus according to the invention;

FIG. 3 shows an implementation of a sequence of electrodes arranged on the counter wheel, in the embodiment shown in FIG. 2;

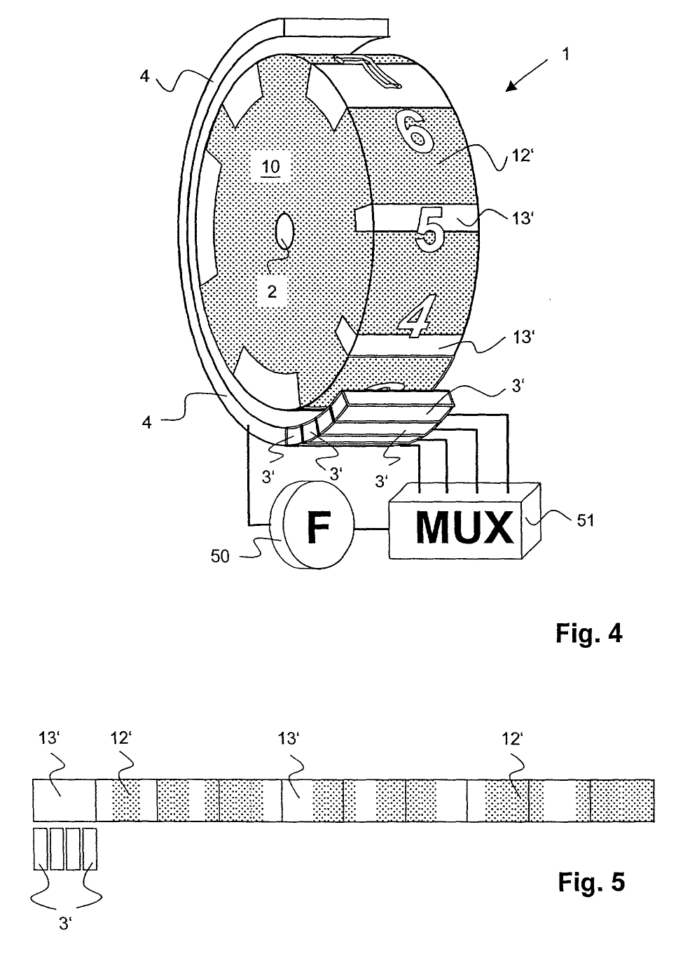

FIG. 4 shows a perspective illustration of a second embodiment of a counter wheel having the reading apparatus according to the invention;

FIG. 5 shows an implementation of a sequence of electrodes arranged on the counter wheel, in the embodiment shown in FIG. 4;

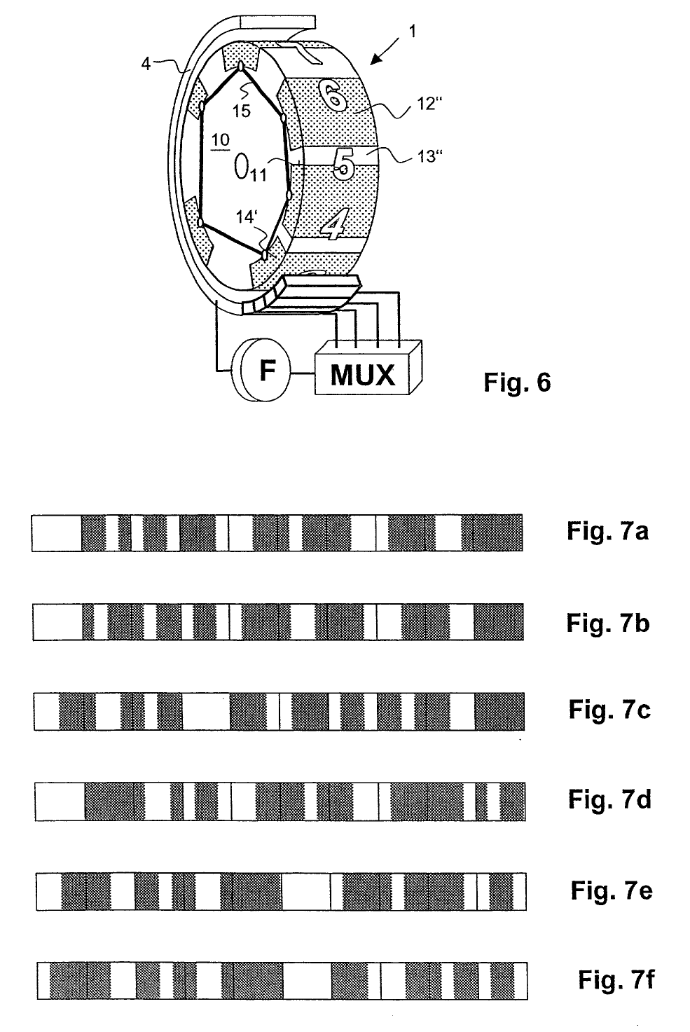

FIG. 6 shows a perspective illustration of a third embodiment of a counter wheel, and

FIGS. 7a to 7f show further implementations of a sequence of electrodes arranged on the counter wheel.

FIG. 1 is a schematic illustration of a wheel counter mechanism according to the invention. It essentially comprises a multiplicity of counter wheels 1 mounted on a common bearing axle or on a plurality of bearing axles 2. The wheel counter mechanism is operatively connected via a gear mechanism to a mechanical movement element (not shown here) whose design varies according to the application area. The mechanical movement element detects a consumed quantity, for example of water or gas, and causes the counter wheels 1 to rotate, in a known manner. In this case, the counter wheels 1 can rotate continuously or in steps.

Each counter wheel 1 of the wheel counter mechanism has a capacitive reading apparatus for the purpose of determining the position of the counter wheel. The reading apparatus essentially comprises a number of fixed electrodes 3, a number of measurement electrodes 12 and evaluation electronics 5. The measurement electrodes 12 are arranged so as to be distributed over the circumference of the counter wheel 1, and, depending on the embodiment, are applied to the surface of, are set into or are formed by the counter wheel. The fixed electrodes 3 are in the form of circle segments and are arranged at a distance from the counter wheel 1, with an air gap inbetween, and are at an at least approximately constant distance from the measurement electrodes. The number of fixed electrodes 3 and also the sequence and number of measurement electrodes 12 depend on the number of positions of the counter wheel which need to be detected. If, as described in the examples below, a total of ten discrete positions need to be detected, then a total of four fixed electrodes 3 is required in order to represent binary values from 0 to 9. In addition, the sequence of the measurement electrodes 12 is determined by the arrangement of the fixed electrodes 3, with two examples of this being shown below.

The evaluation electronics 5 have, for example for each counter wheel, a capacitance meter 50 and a multiplexer 51. The evaluation electronics measure the capacitances present between the fixed electrodes 3 and the measurement electrodes 12, with each capacitance having an associated binary value of 0 or 1. The four fixed electrodes 3 thus together provide a number between 0 and 9 in binary format.

FIG. 2 shows a first, preferred embodiment of the reading apparatus according to the invention: The counter wheel 1 has a counter wheel body 10 with the measurement electrodes 12 formed on its surface. In this embodiment, the measurement electrodes 12 are applied to the surface of the counter wheel body 10 in the form of an electrically conductive layer, in particular a metal layer. In this case, the counter wheel body 10 is made of an electrically nonconductive material, for example plastic, in particular polyacetal. The counter wheel is split into ten virtual sectors S, with one measurement electrode 12 extending over one respective sector S and preferably over the entire width of the counter wheel.

The surface of the body 10 thus holds a sequence of measurement electrodes 12 having electrically nonconductive sections 13 arranged between them. The implementation of this sequence is shown in FIG. 3. A first measurement electrode 12a is followed by a sector having a first nonconductive section 13a, by a second measurement electrode 12b, by two sectors having nonconductive sections 13b, by two sectors which have measurement electrodes 12c but which are electrically isolated from one another, and by three sectors having nonconductive sections 13c.

The fixed electrodes 3 are arranged along the circumference of the counter wheel 1, with an air gap which is at least approximately constant being present between the electrodes 3 and the counter wheel 1. The fixed electrodes 3 are preferably of identical design and preferably extend at least approximately over the entire width of the counter wheel 1. In this example, two respective fixed electrodes 3 are combined in pairs, with four pairs being formed. One electrode in a pair forms a transmitter electrode 30, and the second electrode forms a receiver electrode 31. In this example, the transmitter electrodes 30 are electrically connected to one another. The transmitter electrodes can also be driven individually, however. The receiver electrodes 31 are connected to the evaluation electronics 5 individually, and the transmitter electrodes 30 are connected to the evaluation electronics 5 together.

Each pair of fixed electrodes 3 forms a counterpart for a sector S, with the pair being of corresponding length. In this case, the pairs of fixed electrodes 3 are preferably arranged such that the four pairs are opposite four successive sectors. The four pairs are preferably arranged such that adjacent electrodes in two adjacent pairs are of the same type, that is to say that a transmitter electrode in a first pair is arranged next to a transmitter electrode in a second pair. This allows crosstalk to be reduced.

The sequence of measurement electrodes 12 and of the arrangement of fixed electrodes 3 which is shown in FIGS. 2 and 3 means that, for each position of the counter wheel 1, at least one measurement electrode 12a, 12b is arranged directly opposite a pair of fixed electrodes 3. In addition, a region of the counter wheel which is remote from the fixed electrodes 3 always contains at least one measurement electrode 12c.

If a measurement electrode 12 is in the region of a fixed electrode pair 3, the transmitter electrode 30 indicates charge to the receiver electrode 30′ via the measurement electrode 12. If there is no measurement electrode 12 directly opposite, then virtually no charge is indicated back to the receiver electrode 30′. This makes it possible to allocate a binary value of 0 or 1 to each fixed electrode pair 3. Hence, the sequence shown in FIG. 3 permits all values between 0 and 9 to be detected in binary format.

FIG. 4 shows a second illustrative embodiment. In this example, the body 10 of the counter wheel 1 is made of a conductive material, in particular metal. The body 10 has recesses 11 containing dielectric inserts 14 made of an electrically nonconductive material. This again produces a circumferential sequence of measurement electrodes 12′ and nonconductive sections 13′ on the surface of the counter wheel 1.

This sequence is shown in FIG. 5. Here too, the counter wheel 1 is again split into ten virtual sectors S. A plurality of measurement electrodes 12′ is provided which extend over the entire width of the surface but are not of the same length as the sectors S. The sequence is made up as follows, where s denotes the length of a sector: 1¼ s nonconductive, ½ s conductive, ¼ s nonconductive, ½ s conductive, ¼ s nonconductive, 1 s conductive, ¾ s nonconductive, ¾ s conductive, ¼ s nonconductive, 1 s conductive, ¾ nonconductive, 1 s conductive, ½ s nonconductive, 1¼ s conductive.

The associated arrangement of fixed electrodes 3′ can be seen in FIG. 4. Four fixed electrodes 3′ are provided which are electrically insulated from one another, are arranged in a sequence and together extend at least approximately exactly over one sector S. In addition, an opposing electrode 4 is provided which preferably extends at least approximately over half the circumference of the counter wheel 1, that is to say at least approximately over five sectors S. Both the fixed electrodes 3′ and the opposing electrode 4 are again of at least approximately the same width as the counter wheel 1 and the measurement electrodes 12′. The fixed electrodes 3′ and the opposing electrode 4 are preferably arranged on a common bracket extending around part of the counter wheel 1 at a constant distance.

The opposing electrode 4 is connected to the capacitance meter 50, and the fixed electrodes 3 are connected to the multiplexer 51. This means that values between 0 and 1 can again be detected for all positions of the counter wheel 1 and for each fixed electrode 3, so that values between 0 and 9 can be represented in binary format.

FIG. 6 shows another embodiment of the counter wheel 1. In this case, the body 10 of the counter wheel is made from a nonconductive material, and has recesses 11. The recesses 11 are filled with inserts 14′ which are made of an electrically conductive material, in particular a metal, and form measurement electrodes 12″. The measurement electrodes 12″ are electrically connected to one another by means of connections 15 if they are arranged in the sequence shown in FIG. 5. The connection is not required for a sequence as shown in FIG. 3.

FIGS. 7a to 7f show other implementations which can be used for the counter wheel shown in FIG. 4 or 6.

The apparatus according to the invention makes it possible to determine a plurality of possible positions, with the determination being based on detection of just two capacitance values.

List of designations

| | |
|---|---|
| 1 | Counter wheel |
| 10 | Counter wheel body |
| 11 | Recess |
| 12 | Measurement electrode |
| 12a | First measurement electrode |
| 12b | Second measurement electrode |
| 12c | Third measurement electrode |
| 12′ | Measurement electrode |
| 12″ | Measurement electrode |
| 13 | Nonconductive section |
| 13′ | Nonconductive section |
| 14 | Nonconductive insert |
| 14′ | Conductive insert |
| 15 | Electrical connection |
| 2 | Bearing axle |
| 3 | Fixed electrode |
| 30 | Transmitter electrode |
| 31 | Receiver electrode |
| 3′ | Fixed electrode |
| 4 | Opposing electrode |
| 5 | Evaluation electronics |
| 50 | Capacitance meter |
| 51 | Multiplexer |
| S | Virtual sector |

1. An apparatus for capacitively determining a position of a counter wheel (1), where fixed electrodes (3, 3′) are arranged at a distance from the counter wheel (1), and the counter wheel (1) has means for changing a capacitance on the basis of position, characterized in that the means for changing the capacitance on the basis of position are a sequence of measurement electrodes (12, 12′, 12″) extending over the circumference of the counter wheel (1), and electrically nonconductive sections (13, 13′) arranged between said measurement electrodes.

2. The apparatus as claimed in claim 1, characterized in that the fixed electrodes (3, 3′) are arranged along the circumference of the counter wheel (1).

3. The apparatus as claimed in claim 1, characterized in that the counter wheel has a body made of an electrically nonconductive material.

4. The apparatus as claimed in claim 1, characterized in that the counter wheel (1) has a body (10) made of an electrically conductive material having recesses (11) which are distributed over the circumference and contain electrically nonconductive inserts (14).

5. The apparatus as claimed in claim 1, characterized in that the fixed electrodes (30, 31) are combined in pairs, in that all the measurement electrodes (12) on the counter wheel (1) are of the same length and in that each pair is of a common length which corresponds to the length of the measurement electrodes (12) on the counter wheel.

6. The apparatus as claimed in claim 5, characterized in that each pair of electrodes comprises a transmitter electrode and a receiver electrode (30, 31), with adjacent electrodes in two adjacent pairs being of the same type.

7. The apparatus as claimed in claim 1, characterized in that an opposing electrode (4) is provided which extends along at least half the circumference of the counter wheel (1) at a distance therefrom.

8. The apparatus as claimed in one of claims 5 or 7, characterized in that four fixed electrodes (3′) or four electrode pairs (3) are provided.

9. The apparatus as claimed in claim 1, characterized in that the distance between the measurement electrodes (12, 12′, 12″) and the fixed electrodes (3, 3′), which are respectively opposite them, according to the position of the counter wheel, is at least approximately the same.

10. The apparatus as claimed in claims 5 and 7, characterized in that the sequence distributed over the circumference is implemented as shown in FIG. 3.
